(19) United States
(12) Patent Application Publication
(10) Pub. No.: US 2016/0144426 A1
(43) Pub. Date: May 26, 2016

(54) METHOD AND DEVICE FOR CASTING CONNECTORS

(71) Applicant: ROSENDAHL NEXTROM GMBH, Pischelsdorf (AT)

(72) Inventors: Christian ARZT, Pollau (AT); Rainer Richard PROKOP, Buch-St. Magdalena (AT); Bernd BULTERMANN, Graz-Weinitzen (AT); Christian Gunther SPARI, Bad Gams (AT); Lukas Martin SIMONITSCH, Graz (AT)

(21) Appl. No.: 14/900,456

(22) PCT Filed: May 15, 2014
(86) PCT No.: PCT/AT2014/000110

§ 371 Date: Dec. 21, 2015

(30) Foreign Application Priority Data
Jun. 20, 2013 (AT) A 503/2013

(51) Int. Cl. B22D 25/04; B22D 17/12; B22D 17/30; H01M 2/20; B22D 21/02; B22D 39/02; H01M 10/12; B22D 19/04; B22D 17/22

(52) U.S. Cl. CPC B22D 25/04; B22D 19/04; B22D 17/12; B22D 17/30; B22D 17/2236; B22D 21/027; B22D 39/023; H01M 10/12; H01M 2/206

(57) ABSTRACT

A metering unit (14) for molten lead is paired with the molding cavity (13) of a molding block (6). The metering unit (14) includes a cylinder (1), to which molten lead is supplied via a blockable line (8), and a piston (2), which can be lifted in order to transfer molten lead into the molding cavity (13) in order to cast pole connectors onto battery plate lugs.

The invention relates to a method and a device for casting pole connectors (pole bridges) onto the lugs of positive or negative lead plates of lead-acid batteries.

The connectors are used to connect to one another, in an electrically-conducting manner, the positive lead plates, on the one hand, and the negative lead plates, on the other hand, of the plate packets of lead-acid batteries.

Such methods (“casting methods”) and devices (“casting molds”) are known. Reference is made by way of example to EP 1 339 514 A, EP 1 590 113 A, EP 2 001 620 A, WO 99/04919 A, EP 0 630 526 A, and WO 91/05625 A.

A known casting mold consists of a molding block, in which recesses are provided to form the pole connectors (in English: straps). The shape of the molding cavities corresponds to the negative of the respective connector. In addition, two feeds for liquid lead are provided, which feeds are connected to one another (crossblock).

Finally, in the known casting mold, a base plate is provided with an ejector unit. The casting mold furthermore comprises a coupling unit, which takes over the function of connecting the casting mold to the control device and to a cooling system of a casting machine.

The mode of operation of a casting mold according to the state of the art can be described by way of example as follows:

The feed for liquid lead that is designed as a channel is filled with liquid casting lead, which is fed by a pump from a reservoir (melting pot) for liquid lead. The fill level in the channel is at the same height as an open overflow that is mounted on the pump.

During the casting process, the overflow of the pump is closed by a valve, and the pump speed is increased. This has the result that the fill level in the open lead conveying channel rises and flows via the separating strip (“weir”) into the recesses in the molding block. At the end of the fill process, all recesses are filled with lead and have a somewhat elevated level. Then, the pump is turned off for a short time, and the conveying of lead ends. At the same time, the return valve is opened, and the elevated level of liquid lead in the mold begins to drop again until the level of the lead in the recesses of the mold that form the connector has dropped to the height of the separating strip.

Excess lead flows back again into the melting pot via the overflow of the pump. In order to accelerate the lead reflux, the intake valve also opens so that lead can flow back through the stationary pump wheel. In addition, a dump valve is also opened in order to direct the lead directly back into the melting pot. During the fill process, the elements (plate groups that consist of positive and negative battery plates) are provided in a tightening cartridge (jig-box) for immersion in the molten lead, which is located in the molding cavities of the molding block. The plates are immersed in the lead after the end of a freely adjustable time span. This begins as soon as the pump is turned off and the level of lead begins to drop.

When the plates (more precisely: their lugs) have been immersed in the molten lead, the cooling time begins in order to cool and to harden the lead of the connector. During this time, the cooling of the mold has the effect that the desired temperature is reached and can be held.

After the cooling time, ejectors are extended, and in this case, the removal mechanism of the tightening cartridge is also actuated. Thus, the solidified connectors that are cast onto the lugs of the battery plates are pressed/raised from the mold, at which point the casting cycle is completed.

From DE 29 25 297 A, a generic device in which molten lead is introduced using a feed pump from a container via supply lines into a molding cavity is known. A metering system that provides the necessary amount of liquid lead is paired with the molding cavity. In DE 29 25 297 A, the feed pump is designed as a reciprocating pump, so that the stroke of the reciprocating pump regulates the amount of molten (liquid) lead. In particular, since, in DE 29 25 297 A, the reciprocating pump is not paired with the molding cavity, but rather with the inflow channel, there is no provision for gauging the amount of lead introduced into molding cavities, since the amount is controlled by the height of a weir, the overflow-reflux system, and/or the suctioning-back of the pump.

EP 0 480 905 A1 describes a method for volume-metered casting of a lead melt for poles and pole bridges, whereby the metering and the filling of the molding cavity in the casting mold are done via a separate system of bucket elevators.

Starting from the above-mentioned state of the art, the object of the invention is to improve a device (casting device) and a method (casting method) of the above-mentioned type with respect to a more precise operating method.

This is achieved according to the invention with a method that has the features of Claim 1.

Insofar as the device according to the invention is affected, this is achieved with the features of the independent claim that is aimed at the device.

Preferred and advantageous configurations of the method according to the invention and the device according to the invention are subjects of the dependent subclaims.

The essential difference of the procedure and device according to the invention relative to the known devices of the state of the art consists in that in the invention, the molding cavities in the molding block are no longer flooded, but rather are filled with a predefined (selectable) amount of liquid lead.

In this case, it is provided according to the invention that the liquid lead is metered in a metering system and then is transferred from the metering system into the molding cavity of the molding block (paired with the metering system).

In this case, it is preferably provided that the molding cavity is filled from below with liquid lead from the metering system, whereby in principle, however, a filling from above is also not ruled out.

Unlike in the state of the art where an attempt is made to meter the molding cavity of the casting mold by flooding with molten lead, in the invention, the amount of molten lead that is necessary in each case for the casting of the pole connectors is provided in the metering system and then is transferred from the metering system into the molding cavity that is paired with the metering system, into which cavity the lugs of the battery plates project.

By adjusting the metering system, this procedure makes it possible to match the amount of molten lead that is necessary in each case and thus to take into account the requirements (battery type, design of the pole connector, the straps of pole connectors for connecting battery plate packets and pole stems located in adjacent cells of a battery).

The method according to the invention can be described in general and by way of example as follows:

In the initial state, the device according to the invention is heated to operating temperature. The lead supply line and the cylinder of the metering system for metering liquid lead into the molding cavity of the molding block are not yet filled with liquid lead.

The piston in the cylinder of the metering system is located in the fill position, i.e., it is retracted, and also the ejector system as well as the system for vernier adjustment of the metering are in the ready position (inactive position). In addition, in this state, the seal that is provided in the lead supply line is in a position in which it interrupts the lead supply line to the cylinder of the metering system.

As a first step, the lead supply line (designed as circulation in the system or closed on one side) is filled with liquid casting lead. In this case, casting lead is pumped into the system by a (flanged) pump from a storage container (“melting pot”) for liquid lead.

At the beginning of the casting process, the lead supply line is opened by a shut-off valve, for example a slide valve, being moved into its position that is open to the lead supply line, and liquid lead flows into the metering cylinder. The fill amount or fill level can be determined either by the position of the intake opening in the metering cylinder, through which liquid lead flows from the lead supply line into the metering cylinder, or alternatively by an overflow system.

Another possibility, which can be selected cumulatively or alternatively to the two above-mentioned possibilities, consists in adjusting the position of the piston in the cylinder of the metering unit corresponding to the desired amount of lead, and optionally the amount of lead can be adjusted in addition by vernier adjustment of the position of the piston of the metering system in the cylinder of the metering unit.

After the cylinder of the metering unit has been filled with liquid lead, the lead supply line is closed again by actuating the shut-off valve (slide valve). The next step is to move the piston in the cylinder toward the molding block by a stroke unit that is paired with the piston until the piston has reached the lower edge of the molding cavity. As a result, the amount of liquid lead that is contained in the metering system, i.e., predefined, is released (transferred) into the molding cavity (cavity). During the filling of the molding cavity with liquid lead, plate groups—onto whose lugs electrically-conducting, connecting pole connectors are to be cast, optionally with straps or pole stems—are provided for immersion in the molten lead in the molding cavity, held, for example, in a tightening cartridge. The lugs of the battery plates in the plate groups can also be immersed in the molding cavity even during the fill process of the molding cavity.

As soon as the battery plates of the plate groups are inserted into the molding cavity with the lugs provided on them and are immersed in the molten lead that is located in the latter, the cooling is begun. By the cooling, the lead of the pole connector, which is connected to the lugs by melting, is cooled, and it becomes solid (solidifies).

As soon as the lead has solidified, the ejectors are extended by actuating the ejection system, and at the same time, the tightening cartridges, by which the plate packets are held, are lifted. Thus, the pole connectors that are hardened and cast onto the lugs of the battery plates in the plate packet are moved out from the mold.

As soon as this has taken place, the pistons of the metering system, the ejection system, and the stroke unit for the piston of the metering system are brought back into the starting position, and the next casting cycle of pole connectors can begin.

In practice, the piston of the metering cylinder can have a diameter of between 3 and 200 mm.

Usually, in the method according to the invention, the procedure is performed at a temperature of the liquid lead of between 360 and 520° C.

In a preferred embodiment of the invention, it is provided that the fill level of liquid lead in the cylinder of the metering system is monitored, for example, by a sensor.

The shut-off valve provided in the lead feed can be a slide valve or a cock.

Other details and features of the invention follow from the description below of a preferred embodiment of a casting device according to the invention with reference to the drawings. Here:

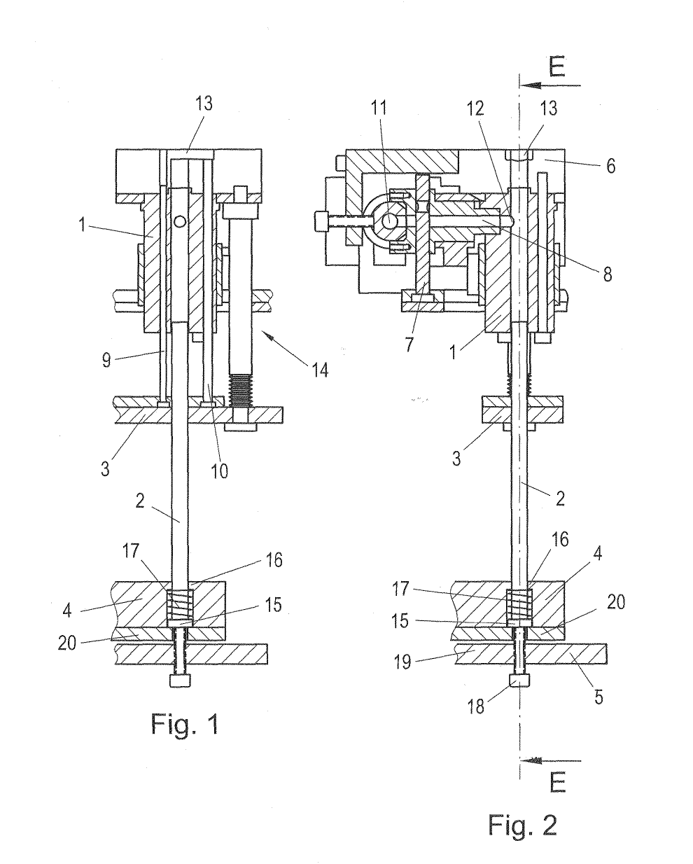

FIG. 1 shows in section (along line E-E in FIG. 2) a casting device,

FIG. 2 shows the casting device of FIG. 1 in a section that is oriented perpendicularly to section E-E, and

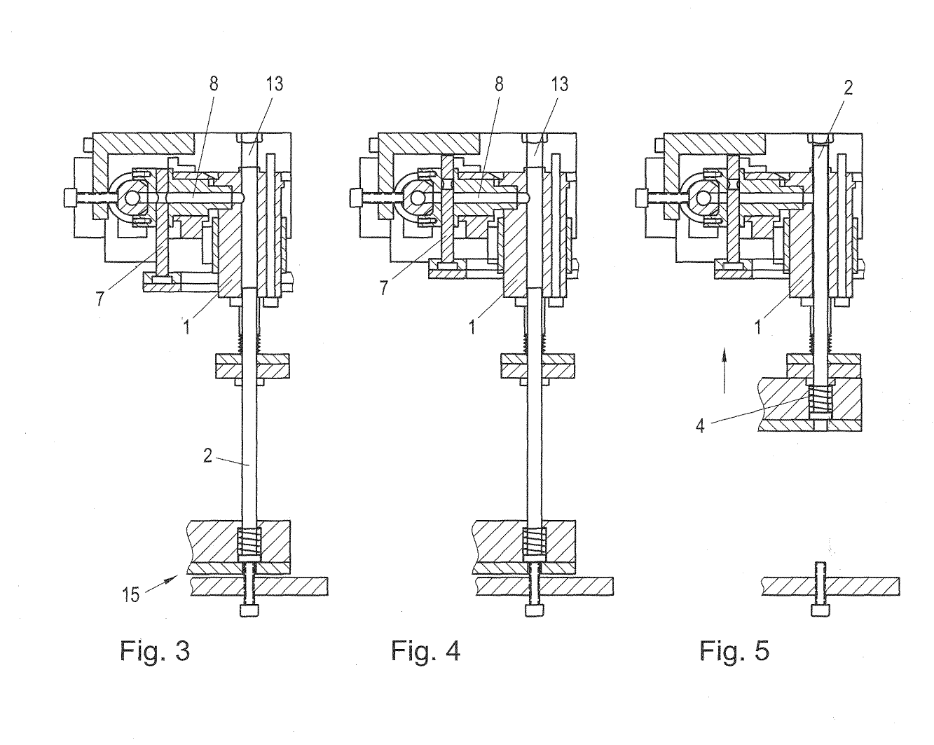

FIGS. 3 to 7 show views according to FIG. 2 at various stages when carrying out a casting process using the device according to the invention.

A casting device that is shown with its essential parts in FIGS. 1 and 2 comprises a metering system 14 with a cylinder 1 and with a piston 2. By actuating the piston 2, liquid lead that is metered into a molding cavity 13 (cavity) can be loaded into a molding block 6 from below. The molding block 6 has at least one molding cavity 13.

To actuate the piston 2 of the metering system 14 in the cylinder 1, a stroke unit 4 is provided.

The end of the piston 2 of the metering system 14 that is paired with the stroke unit 4 bears a flange 15. An elastic element, e.g., a coil spring 17, is arranged between an annular projection 16 of the opening, through which the piston 2 projects into the stroke unit 4, and the flange 15.

A vernier adjustment 5 is paired with the lower end of the piston 2 that is accommodated in the stroke unit 4. The vernier adjustment 5 comprises an adjusting screw 18, which is screwed into a carrier 19. The position of the carrier 19 can be adjusted, but remains unchanged during a casting cycle. By adjusting the adjusting screw 18, the position of the piston 2 can be adjusted in the cylinder 1, while the cylinder 1 is filled with lead. The piston 2, during lifting by the stroke unit 4, is pressed again adjacent to the stop 20 of the stroke unit 4 because of the spring 17. This has the advantage that the piston 2, independent of the position of the vernier adjustment 5 during lifting (filling of the molding cavity 13 with lead), is raised by the amount of the stroke that is set in each case, without the stroke of the stroke unit 4 having to be changed.

Liquid lead is supplied via a lead supply line 8, which is paired with a slide valve 7 as a shut-off valve, from a line 11, which can be designed as a circulation system or closed on one side.

The amount of lead in the metering cylinder 1 is determined, on the one hand, by the position of the piston 2 in the cylinder 1 and, on the other hand, by the position of the mouth 12 of the lead supply line 8 in the recess of the cylinder 1.

The alternative possibility of using an overflow system (with a weir) is not depicted in the drawings.

As mentioned, the amount of lead that is loaded by the metering system 14 into the molding cavity 13 in the molding block 6 can be adjusted in addition by a vernier adjustment system 5, with which the position of the piston 2 in the cylinder 1 can be changed during the filling of the metering system 14 with lead.

The casting device according to the invention also comprises an ejection system 3 with ejectors 9 and 10. Using the ejection system 3 and optionally the piston 2, a pole connector, which has been cast onto the lugs provided on the plates of the plate packet, can be ejected from the molding cavity 13 of the molding block 6.

The mode of operation of the embodiment of a casting device, shown by way of example in FIGS. 1 and 2, for carrying out the casting method according to the invention is described below based on FIGS. 3 to 7.

In FIG. 3, the stage is shown in which liquid lead is loaded into the cylinder 1 through the lead supply line 8 when the slide valve 7 is open until the desired fill level (for example defined by the position of the mouth 12 of the lead supply line 8 in the cylinder 1) is reached.

As soon as the prescribed fill level of liquid lead in the metering system 14 has been reached, the lead supply line 8 is closed by actuating the slide valve 7, so that liquid lead can no longer flow from the lead supply line 8 into the cylinder 1 (FIG. 4).

Now, by actuating the stroke unit 4 of the piston 2, as shown in FIG. 5, the piston 2 moves upward into the cylinder 1 of the metering system 14 in order to load the liquid lead into the molding cavity 13 of the molding block 6. During the filling of the molding cavity 13 with lead or shortly afterward, the lugs of the battery plate packets are immersed in the molding cavity 13. As soon as this has taken place, the molding block 6, and thus the lead that forms a pole connector and that is contained in the at least one molding cavity 13, is cooled.

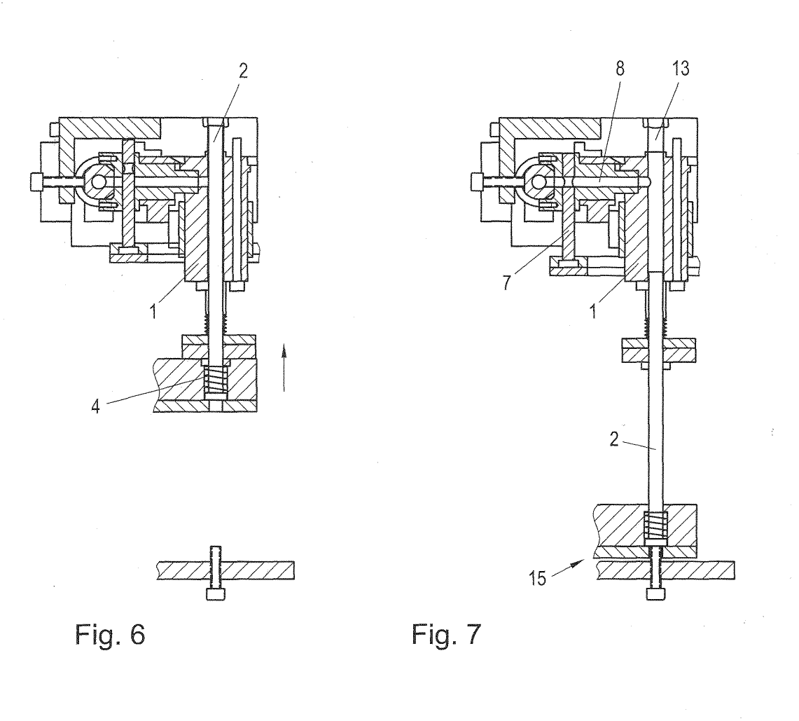

After cooling has ended, the ejectors 9 and 10 and also the piston 2 are moved upward by actuating the ejection system 3 in order to eject the pole connectors cast onto lugs of battery plates from the molding cavity 13 (FIG. 6). In this case, the stroke can be approximately 3 mm.

As soon as this has taken place, the device is retracted into the position according to FIG. 3 (cf. FIG. 7), and a new casting cycle is begun.

In summary, an embodiment of the invention can be described as follows:

A metering unit 14 for liquid lead is paired with the molding cavity 13 of a molding block 6. The metering unit 14 comprises a cylinder 1, to which liquid lead is fed via a blockable line 8, and a piston 2, which can be lifted to transfer liquid lead into the molding cavity 13 in order to cast pole connectors onto lugs of battery plates.

1-20. (canceled)

21. Method for casting pole connectors onto lugs of plates, whereby a molding block (6) with at least one molding cavity (13) is used, whereby a pole connector is cast onto lugs of battery plates by filling the molding cavity (13) with a selectable, predetermined amount of liquid lead and by allowing the lead to solidify,
wherein the amount of liquid lead that is necessary in each case for casting the pole connector is prepared in a metering system (14) that is paired with the molding cavity (13) in the molding block (6) and that comprises a cylinder (1) and a piston (2) that can be moved in this cylinder, whereby the piston (2) in the cylinder (1) of the metering system (14) is located in the fill position, in which the piston is retracted, and
wherein the liquid lead is transferred to the molding cavity (13) from the metering system (14) from below into the molding cavity (13) that is paired with the metering system (14), into which cavity the lugs of the battery plates project, by the piston (2) being moved into the cylinder (1) of the metering unit (14) by a stroke unit (4) that is paired with the piston (2).

22. Method according to claim 21, wherein the piston (2) is moved in the cylinder (1) toward the molding block (6).

23. Method according to claim 21, wherein the molding cavity (13) is closed by actuating a shut-off device, which is paired with the metering system (14).

24. Method according to claim 21, wherein liquid lead is supplied to the metering system (14) via a line (8) that is designed as a circulation system.

25. Method according to claim 21, wherein a line (8) for feeding molten lead that empties into the recess of the cylinder (1) of the metering unit (14) is closed by a shut-off device (7) during the transfer of molten lead into the molding cavity (13).

26. Method according to claim 25, wherein a slide valve is used as the shut-off device (7).

27. Method according to claim 25, wherein a cock is used as a shut-off device.

28. Method according to claim 21, wherein the amount of molten lead that is prepared in the metering system (14) is adjusted in addition by vernier adjustment of the position or the movement of the piston (2) of the metering system (14) in the cylinder (1) of the metering unit (14).

29. Method according to claim 21, wherein after the lead is solidified in the molding cavity (13), ejectors (9, 10) are actuated, and the pole connectors that are hardened and cast onto the lugs of the battery plates in the plate packet are moved out from the molding cavity (13).

30. Method according to claim 21, wherein the piston (2) in the cylinder (1) is lifted until the piston is in a discharge position.

31. Method according to claim 22, wherein the molding cavity (13) is closed by actuating a shut-off device, which is paired with the metering system (14).

32. Method according to claim 22, wherein liquid lead is supplied to the metering system (14) via a line (8) that is designed as a circulation system.

33. Method according to claim 23, wherein liquid lead is supplied to the metering system (14) via a line (8) that is designed as a circulation system.

34. Method according to claim 22, wherein a line (8) for feeding molten lead that empties into the recess of the cylinder (1) of the metering unit (14) is closed by a shut-off device (7) during the transfer of molten lead into the molding cavity (13).

35. Method according to claim 23, wherein a line (8) for feeding molten lead that empties into the recess of the cylinder (1) of the metering unit (14) is closed by a shut-off device (7) during the transfer of molten lead into the molding cavity (13).

36. Method according to claim 24, wherein a line (8) for feeding molten lead that empties into the recess of the cylinder (1) of the metering unit (14) is closed by a shut-off device (7) during the transfer of molten lead into the molding cavity (13).

37. Method according to claim 22, wherein the amount of molten lead that is prepared in the metering system (14) is adjusted in addition by vernier adjustment of the position or the movement of the piston (2) of the metering system (14) in the cylinder (1) of the metering unit (14).

38. Method according to claim 23, wherein the amount of molten lead that is prepared in the metering system (14) is adjusted in addition by vernier adjustment of the position or the movement of the piston (2) of the metering system (14) in the cylinder (1) of the metering unit (14).

39. Method according to claim 24, wherein the amount of molten lead that is prepared in the metering system (14) is adjusted in addition by vernier adjustment of the position or the movement of the piston (2) of the metering system (14) in the cylinder (1) of the metering unit (14).

40. Method according to claim 25, wherein the amount of molten lead that is prepared in the metering system (14) is adjusted in addition by vernier adjustment of the position or the movement of the piston (2) of the metering system (14) in the cylinder (1) of the metering unit (14).
